(19) United States
(12) Patent Application Publication
(10) Pub. No.: US 2004/0190494 A1
(43) Pub. Date: Sep. 30, 2004

(54) Systems and methods for voice quality testing in a non-real-time operating system environment

(76) Inventor: Samuel M. Bauer, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/400,223

(22) Filed: Mar. 26, 2003

(51) Int. Cl. H04L 12/66

(52) U.S. Cl. 370/352

(57) ABSTRACT

Systems and methods for voice quality testing (VQT) under a non-real-time operating environment. An internal scheduling mechanism (ISM) thread is periodically executed according to a schedule on a processing system. When test data is available in an “encode” queue, the timer thread calls a player routine that encodes the test data and delivers it to an “encoded” queue. The encoded test data is taken from the “encoded” queue and transmitted over a packet-switched network. The ISM can also be used to direct the transfer of data from a de-jitter buffer and control subsequent processing of the data. Queues and processes may be reset between tests to prevent corruption of data and ambiguous process states.

### BACKGROUND

Traditionally, digital voice communication has relied primarily on circuit-switched networks such as the T-carrier system. However, packet-switched networks (e.g. the Internet) that were initially developed for data transmission applications, are being increasingly used for voice communications. The successful adoption of packet-switched networks for voice communication is dependent upon achieving a consistent level of quality that is at least comparable to that of cellular voice communications, and preferably equivalent to standard carrier quality.

In order to gauge voice communication performance over a packet-switched network, various methods of voice quality testing (VQT) have been developed. Among the factors that determine the voice quality is delay. Delay is the time it takes sound to travel from the source to the listener. For calls established on terrestrial circuit switched networks, delays are usually on the order of a few tens of milliseconds. In comparison, the threshold of delay at which conversation is impaired is on the order of 150 milliseconds.

A limited amount of variation in delay can be accommodated if the variation in delay, or jitter, is not excessive. For example, the delay associated with typical audio codecs is usually less than 10 milliseconds and jitter is on the order of a few milliseconds. However, non-real-time operating systems such as Microsoft Windows™ will occasionally hold off application processing for hundreds of milliseconds. This amount of interruption could be tolerated and compensated for if it were consistent and predictable, or measurable. The fact that it is not, cannot be tolerated by high-precision test equipment.

Real-time operating system platforms provide the ability to achieve consistent latency between software components. Non-real-time operating systems such as Microsoft Windows™ do not. As a matter of course, under a non-real-time operating system, the application designer cannot control to any precise degree how the central processing unit (CPU) is utilized, and when an application can be interrupted. Although applications such as Microsoft NetMeeting™ are capable of tolerating the highly variable delays of a non-real-time operating system, applications designed for VQT do not have the same level of tolerance.

In order to achieve consistent and accurate scores for VQT measurements, it is critical that data is encoded in a timely fashion and packets are transmitted on a very regular interval with minimal jitter. On the receive side, failure to process incoming packets quickly can cause packets to get lost. For VQT applications, it is vital to provide a clean network interface that does not introduce additional degradation into the signal being measured.

Unfortunately, voice communications applications are frequently executed in non-real-time operating system environments. Accordingly, methods are sought for running VQT applications reliably in a non-real-time operating system environment.

### SUMMARY

Embodiments of the present invention pertain to systems and methods for voice quality testing (VQT) in a non-real-time operating system environment. A periodic timer thread is used to control the encoding and flow of test data. When used in conjunction with a number of buffers, the timer thread enables the test functions of a VQT application to avoid being disturbed by the unpredictable latency of the non-real-time operating system.

Systems and methods for voice quality testing (VQT) under a non-real-time operating environment are described. An internal scheduling mechanism (ISM) thread is periodically executed according to a schedule on a processing system. When test data is available in an “encode” queue, the timer thread calls a player routine that encodes the test data and delivers it to an “encoded” queue. The encoded test data is taken from the “encoded” queue and transmitted over a packet-switched network. The ISM can also be used to direct the transfer of data from a de-jitter buffer and control subsequent processing of the data.

In one embodiment, a maximum priority internal scheduling mechanism (ISM) thread is periodically executed according to a fixed schedule on a first processing system. When test data is available in an “encode” queue, the timer thread calls a player routine that encodes the test data and delivers it to an “encoded” queue. The encoded test data is taken from the “encoded” queue and transmitted over a packet-switched network to a second processing system where the data is received in a de-jitter buffer. An ISM thread executed on the second processing system directs the transfer of the data from the de-jitter buffer and subsequent processing of the data.

In another embodiment, ambiguities in the system are eliminated by resetting the states of encoding and packetizing functions in the system. Buffers and queues can also be cleared. Play/record synchronization can be achieved by sequentially resetting the player routine in the first processing system, resetting the processing routines in the second processing system, initiating the player routine, and starting the processing routines in the second system upon receipt of the next packet.

### BRIEF DESCRIPTION OF THE DRAWINGS

The accompanying drawings, which are incorporated in and form a part of this specification, illustrate embodiments of the invention and, together with the description, serve to explain the principles of the invention. The drawings referred to in this description should not be understood as being drawn to scale except if specifically noted.

FIG. 1 is block diagram of a packet-switched network voice communication system in accordance with an embodiment of the present invention.

FIG. 2 shows a protocol stack used for voice quality testing in a communications network, mapped onto the Open Systems Interconnect (OSI) model, an accordance with an embodiment of the present invention.

FIG. 3 shows an embodiment of the present invention in a non-real-time operating system environment.

FIG. 4 shows a data flow diagram for data buffers and queues, in accordance with an embodiment of the present invention.

FIG. 5 shows a flow diagram for a method for voice quality testing (VQT) in a non-real-time operating system environment in accordance with an embodiment of the present invention.

### DETAILED DESCRIPTION OF THE INVENTION

### Terminology and Overview

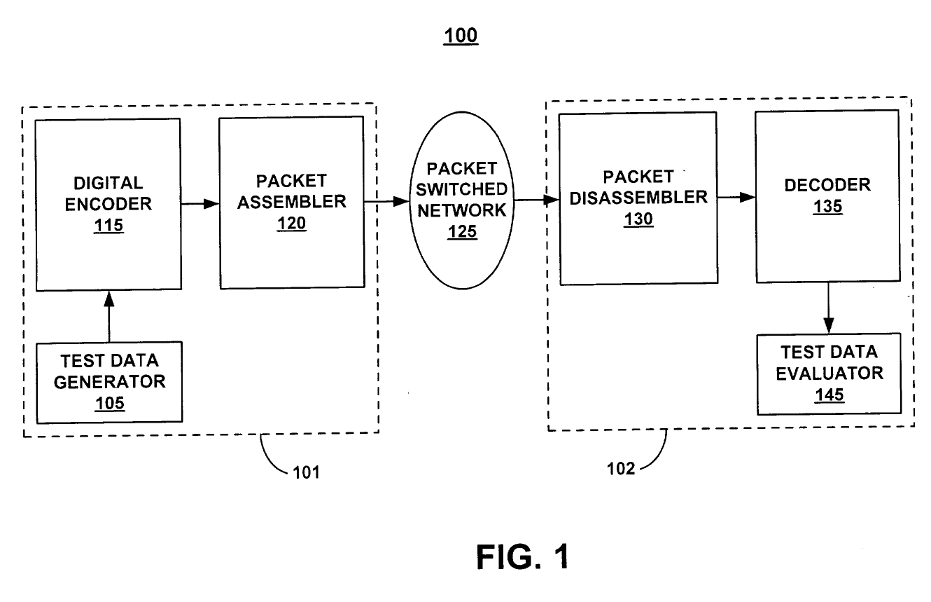

FIG. 1 shows a functional block diagram 100 for a representative voice communication system and test setup. The system comprises a first processing system 101 and second processing system 102, each running a non-real-time operating system and coupled by a packet-switched network 125. The first processing system 101 comprises the general elements of a test data generator 105 for producing input data, a digital encoder 115 for encoding the input data, and a packet assembler 120 for packetizing the encoded data. The second processing system 102 comprises the general elements of a packet disassembler 130 for extracting data from packets, a decoder 135 for decoding encoded data, and a test data evaluator 145.

The test data generator 105 produces voice test data that is encoded by the digital encoder 115. Digital encoding includes the analog-to-digital conversion of the analog signal 110, and can also include compression, encryption, and other digital signal processing. The digital encoding can be an application running under the non-real-time operating system, or it can be provided as a service by the operating system.

The data encoded by the digital encoder is passed to the packet assembler 120 that converts the information to a series of packets for transmission over the packet-switched network 125. The packet-switched network 125 transports the packets produced by the packet assembler 120 to the packet disassembler 130 of the second processing system 102. Due to variation in packet transmission times, the packet disassembler can include a de-jitter buffer.

The packet disassembler 130 receives the packets from the packet-switched network 125 and extracts the digital information sequence that was produced by the digital encoder 115. The recovered digital sequence is passed to a decoder 135 that produces an output test data. The output test data is passed to a test data evaluator 145.

The test data evaluator 145 compares the received data to the input data. In evaluation, the differences between the input and output data are determined. Among the factors influencing the quality of the output data are the losses and/or jitter that are involved in the transmission over the network, and the distortion introduced during the encoding process. In general, there are a number of factors involved in determining voice quality. Among these factors are delay, echo, and clarity.

Although delay and echo are relatively easy to quantify and understand, clarity is considerably more difficult to quantify. Historically, clarity has been measured using the mean opinion score (MOS), derived from a group of live listeners. More recently, computer-based methods have been developed to produce objective measurements of perceived voice quality.

Two examples of clarity measurement techniques are the Perceptual Speech Quality Measurement (PSQM) method, and the Perceptual Analysis/Measurement System (PAMS) method. Recently, the Perceptual Evaluation of Speech Quality (PESQ) model has been introduced, combining elements of both PSQM and PAMS. These can involve intensive computation.

Voice quality testing (VQT) is ideally a real-time process; however, in a non-real-timesoperating system environment, the computational demands of a particular process within the chain (e.g. test data evaluation) may be allocated system resources for an excessive period of time leading to packet loss and other problems. In order to minimize problems, the test application should be run at the highest priority permitted by the operating system.

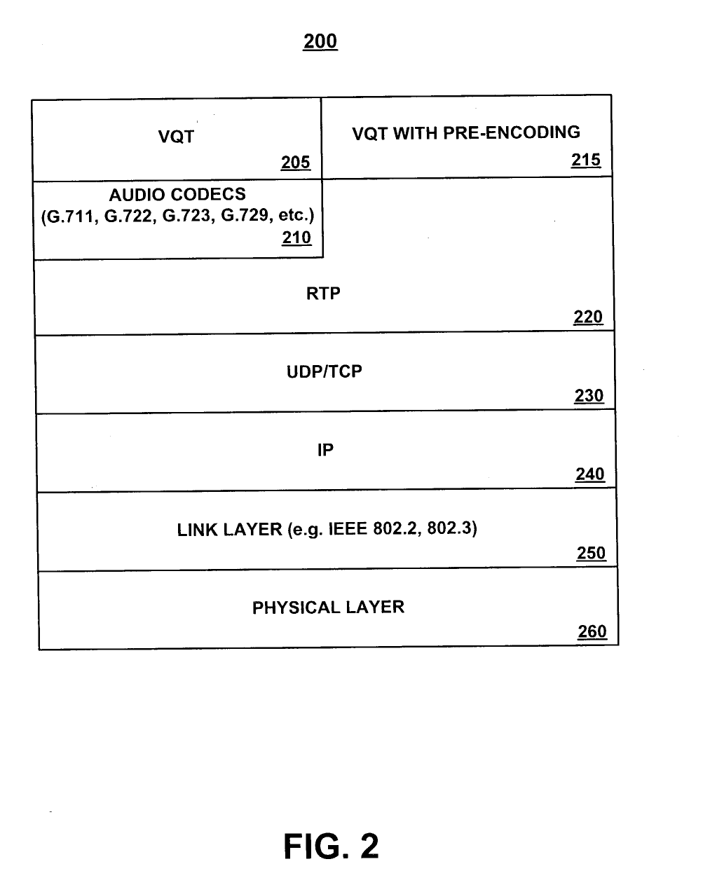

FIG. 2 shows an example of a protocol stack 200 that can be used in conjunction with the system shown in FIG. 1. The protocol stack is mapped onto the Open Systems Interconnect (OSI) model. Embodiments 205 and 215 are shown for the application layer. The VQT application 205 is separated from the encoding functions provided by the audio codecs in the presentation layer 210. In contrast, application 215 uses pre-encoded audio files, and bypasses the audio codecs of the presentation layer 210

The VQT with pre-encoding 215 is disclosed in a U.S. patent application titled “Systems and Methods for Voice Quality Testing in a Packet-Switched Network,” assigned to the assignee of the present application and filed on Mar. 19, 2003; the entire contents of which are incorporated herein by reference.

The presentation layer 210 includes audio codecs that can be used for voice coding (vocoding). Such codecs can include G.711, G.722, G.723, G.729, and their variants. The presentation layer can also provide formatting, code conversion, compression, and encryption.

The session layer 220 can include the Real-Time Transport Protocol (RTP), which provides the first stage of packetization of the coded voice. RTP provides support for applications with real-time properties, including timing reconstruction, loss detection, security and content identification. In general, the session layer provides for the setup and maintenance of connections to a process between two different users (call channels).

The transport layer 230 can include the User Datagram Protocol (UDP). This layer handles the second stage of packetization. The transport layer handles error recovery and flow control between endpoints on the network.

The network layer 240, data link layer 250, and physical layer 260 are concerned with the internal functions of the packet-switched network. The network layer 240 can include the Internet Protocol (IP), and the data link layer can include IEEE 802.2 and 802.3 logical link control (LLC) and media access control (MAC) layers. The network layer and data link layer provide framing and other services for node-to-node transfer within the packet-switched network. The physical layer provides the interface to the physical medium over which the data is sent.

Layers 210 through 260 may be provided as services of the operating system, or they may be provided by a call to another application that is mediated by the operating system. As can be seen for FIG. 2, much of the overall processing is beyond the scope of the VQT application, and under the control of the non-real-time operating system.

Most of the processes involved in setting up and maintaining a voice channel, e.g., a Voice over Internet Protocol (VoIP) telephone call, will be independent of the test application. The call setup and maintenance processes can also compete with the test application during periods when test data is not being delivered and the call is silent.

### Systems for VQT Under a Non-Reak-Time Operating System

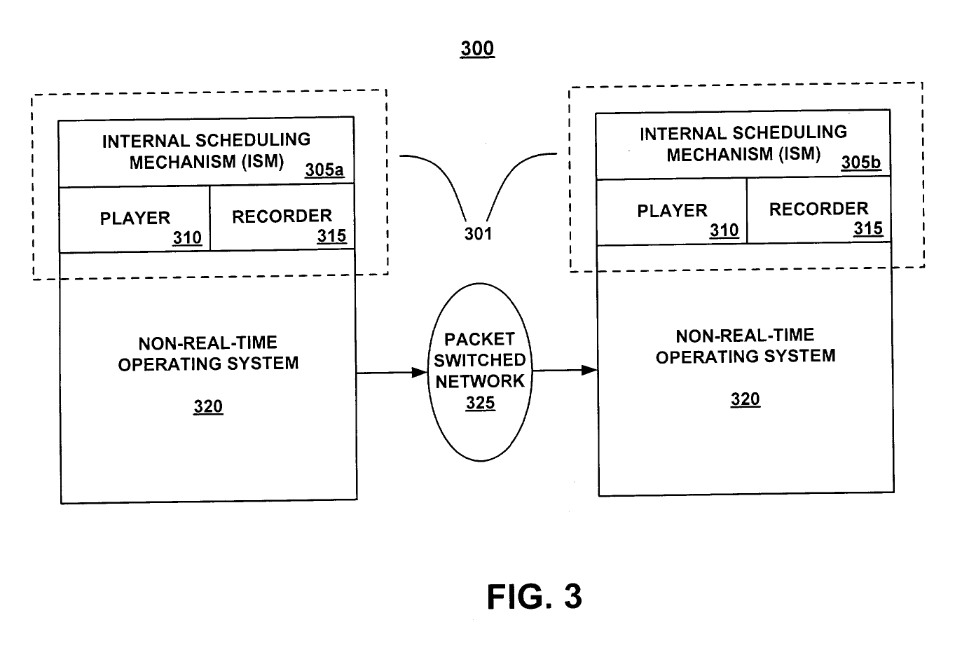

FIG. 3 shows an embodiment of a test system schematic diagram 300 for a non-real-time operating system 320. The non-real-time operating system 320 provides test application 301 with an interface to the packet-switched network 325. The application 301 comprises an internal scheduling mechanism (ISM) that runs as a high priority thread on the operating system 320. In the example of FIG. 3, the ISM instance 305a is controlling test transmission, while ISM instance 305b is controlling test reception. The ISM module can be invoked to provide transmission or reception control. Alternatively, a dedicated transmit or receive ISM module may be combined with either a player or a recorder alone to provide test transmission or test reception capability.

The ISM (305a or 305b) is a single periodic thread of execution that maintains a fixed interval for its execution, e.g., every 10 milliseconds. The interval is typically less than 100 milliseconds. Each time the ISM thread is about to terminate, it determines the elapsed time since its last completed execution, then schedules itself to run again, so that it will run again on the next even interval. For example, for a 10 millisecond interval, if 14 milliseconds have elapsed, it would schedule itself to run again in 6 ms. The length of the fixed interval can be selected so that data queues and buffers are serviced at a rate that avoids under-runs, thus avoiding execution of the thread when there is no available data. At the same time, the interval can be selected so that the buffers and queues are not allowed to become too full, thus providing the necessary storage for data at times when a scheduled interval is missed due to unexpectedly high latency in the operating system.

If the elapsed time is greater than 2 full intervals (e.g., 20 milliseconds), the ISM runs additional processing cycles to catch up. Although running the ISM at a high priority can at times provide the ISM with more processing time than is necessary, the self-scheduling prevents the ISM from receiving resources that it does not need. Simply running the ISM at a high priority without scheduling can result in an unused allocation resources to the ISM that can lead to an increased demand from other processes. The increased demand from other processes can subsequently cause a lack of allocated resources when the ISM actually needs them.

The ISM controls the player process 310 and recorder process 315. The player 310 provides the data to the encoder through interaction with the operating system 320, and the recorder 315 receives packetized data from the network 325, also through interaction with the operating system 320.

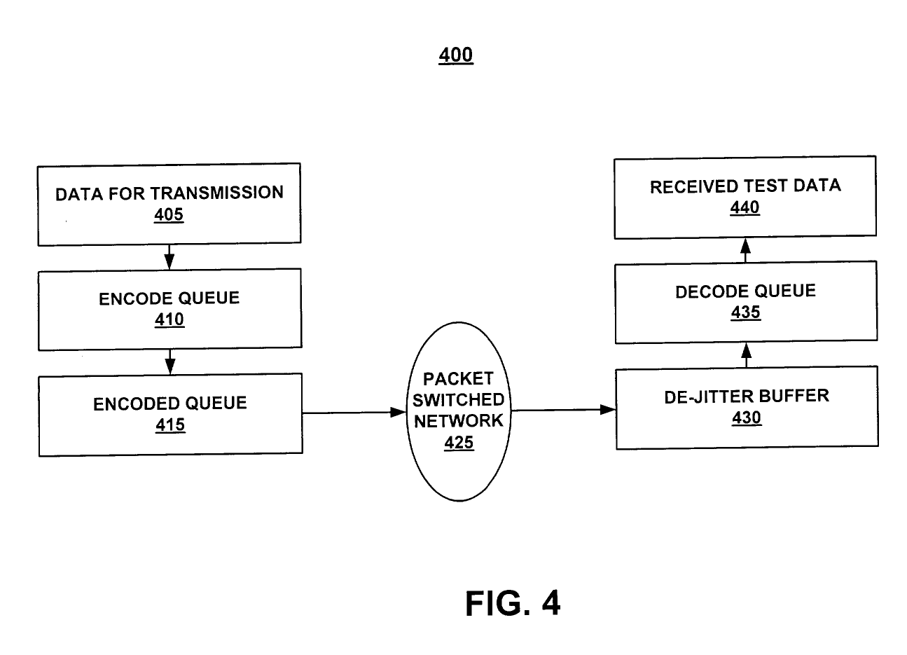

FIG. 4 shows one embodiment of a flow diagram 400 for the flow of test data through buffers and queues of a voice communications system under test. Test data 405 that is to be transmitted is placed in an encode queue 410. After encoding, the data is placed into an encoded queue 415 where it awaits packetizing and transmission over the packet-switched network 425. Data from the network 425 is received by a de-jitter buffer 430 that enables restoration of the transmitted packet sequence. The data is passed from the de-jitter buffer 430 to a decode queue 435. Data from the decode queue 435 is then decoded to produce the received test data.

### Methods For VQT Under a Non-Real-Time Operating System

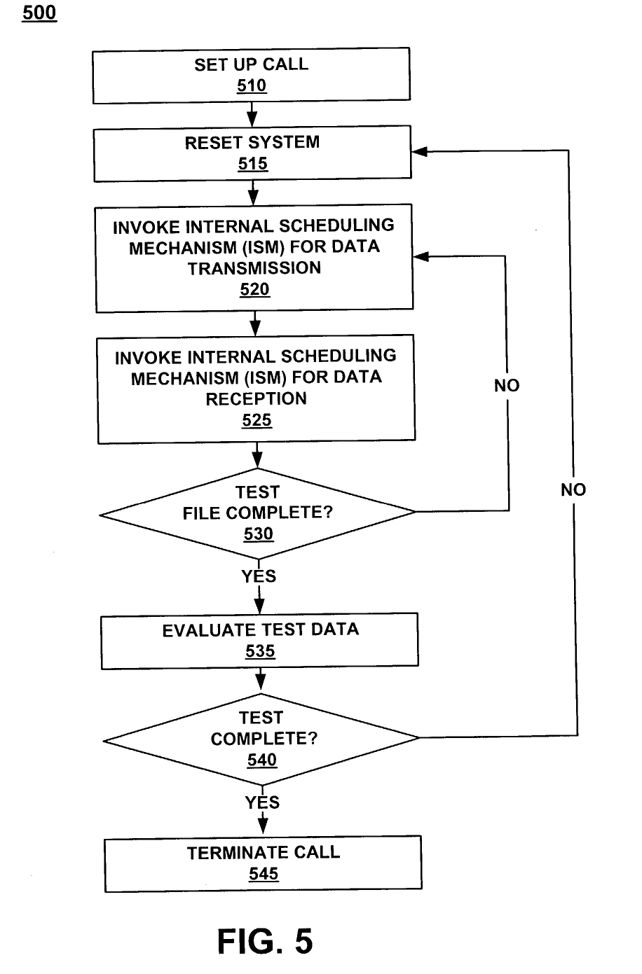

FIG. 5 shows a flow diagram 500 for a method for performing voice quality testing (VQT) in a non-real-time operating system environment in accordance with an embodiment of the present invention. In step 510, a voice call is set up. The call setup is typically done using services provided by the operating system or an application external to the application performing the test.

In step 515, the test system and the voice communication are reset. Prior to “playing” a reference audio buffer, the packetizer and encoder queues, buffers, and states are reset, so that any catching-up or settling that may be occurring due to a disruption in media processing, whether due to the operating system or the VQT application itself, will be stopped. Prior to “recording” an audio buffer, the de-jitter buffer queues and states are reset, so that any catching-up, or settling that may be occurring due to a disruption in media processing, weather due to the operating system or the VQT application itself, will be stopped. It is important for generating repeatable test scores (e.g., clarity and delay scores).

In step 520, an internal scheduling mechanism (ISM) is invoked to schedule the play activity during the transmission of a test data file over the system. The ISM runs according to a fixed scheduled interval so that the variability of the latency of the non-real-time operating system and its effects are minimized during transmission of the test data file. Each execution of the ISM typically results in a portion of the test file data being transmitted.

In step 525, an internal scheduling mechanism (ISM) is invoked to schedule the record activity during the reception of the test data file being transmitted in step 520. The ISM runs according to a fixed scheduled interval so that the variability of the latency of the non-real-time operating system and its effects are minimized during transmission of the test data file. Each execution of the ISM typically results in a portion of the test file data being received and decoded.

In step 530, a check is made to see if the file transmission and reception are complete. If the file has not been received (or timed out due to system error) then step 520 is repeated. After the test file is complete, usually after repeated execution of the ISM, step 535 is executed. The test measurement player and recorder can be synchronized by resetting the player, then the recorder, then starting the test. The recorder will then start recording when the next packet is received.

In step 535, the received test file is evaluated by comparing it to the known transmitted file. After evaluation of the test file, a check is made at step 540 to see if the test is complete. If the test is not complete, then step 515 is repeated. If the test is complete, the call is terminated at step 545.

In summary, embodiments of the present invention provide methods and systems thereof for reliably running VQT applications under a non-real-time operating system. The negative impact of unpredictable latencies in non-real time operating systems can be reduced.

Various embodiments of the present invention are thus described. While the present invention has been described in particular embodiments, it should be appreciated that the present invention should not be construed as limited by such embodiments, but rather construed according to the following claims.

What is claimed is:

1. A system for voice quality testing of a packet-switched voice communications network under a non-real-time operating system comprising:
an internal scheduling mechanism (ISM) for executing as a high priority thread, wherein said ISM runs according to a fixed scheduled interval;
a player executed under the control of an instance of said ISM for providing test data to said voice communications network; and
a recorder executed under the control of an instance of said ISM for receiving test data over said voice communications network.

2. The system of claim 1, further comprising an encode buffer.

3. The system of claim 1, further comprising an encoded buffer.

4. The system of claim 1, further comprising a de-jitter buffer.

5. The system of claim 1, further comprising a decode buffer.

6. The system of claim 1, further comprising a test data evaluator.

7. The system of claim 1, wherein said fixed scheduled interval is less than 100 milliseconds.

8. A method for voice quality testing of a packet-switched voice communications network under a non-real-time operating system comprising:
periodically executing an internal scheduling mechanism (ISM) as a high priority thread, wherein said ISM runs according to a fixed scheduled interval;
executing a player process under the control of said ISM for providing test data to said voice communications network;
packetizing said test data;
transmitting said test data over said packet-switched voice communications network; and
executing a recorder process under the control of said ISM for receiving test data over said voice communications network.

9. The method of claim 8, further comprising passing said test data from said player process to an encode buffer.

10. The method of claim 9, further comprising encoding said test data using an audio codec.

11. The method of claim 10 wherein said audio codec is selected from the set consisting of ITU-T standards G.711, G.723.1, G.728, and G.729.

12. The method of claim 8, further comprising receiving said test data in a de-jitter buffer.

13. The method of claim 8, further comprising evaluating said test data.

14. The method of claim 8, wherein said ISM is periodically executed at a fixed scheduled interval that is less than 100 milliseconds in duration.

15. A method for voice quality testing for a packet-switched voice communications network using a test data file comprising:
setting up a voice call on said packet-switched voice communications network;
resetting said voice communications network;
invoking an internal scheduling mechanism (ISM) to control data transmission of a portion of said test data file over said packet-switched voice communications network; and
invoking an internal scheduling mechanism (ISM) to control data reception and decoding over said packet-switched voice communications network.

16. The method of claim 15, further comprising repeating said invoking an internal scheduling mechanism (ISM) to control data transmission of a portion of said test data file over said packet-switched voice communications network and said invoking an internal scheduling mechanism (ISM) to control data reception and decoding over said packet-switched voice communications network, until said test file is received and decoded.

17. The method of claim 16 further comprising evaluating said test data file.

18. The method of claim 17 wherein said evaluating is done using PSQM.

19. The method of claim 17 wherein said evaluating is done using PAMS.

20. The method of claim 17 wherein said evaluation is done using PESQ.
